(19) United States
(12) Patent Application Publication
(10) Pub. No.: US 2025/0371617 A1
(43) Pub. Date: Dec. 4, 2025

(54) PRIORITIZED DATABASE SEARCH BASED ON IMMINENT INTERACTION

(71) Applicant: Capital One Services, LLC, McLean, VA (US)

(72) Inventors: Galen RAFFERTY, Mahomet, IL (US); Jeremy GOODSITT, Champaign, IL (US); Grant EDEN, San Francisco, CA (US); Samuel SHARPE, Cambridge, MA (US); Anh TRUONG, Champaign, IL (US)

(21) Appl. No.: 19/298,467

(22) Filed: Aug. 13, 2025

Related U.S. Application Data
(63) Continuation of application No. 17/821,098, filed on Aug. 19, 2022.

(51) Int. Cl. G06Q 40/04; G06Q 30/0601

(52) U.S. Cl. CPC G06Q 40/04; G06Q 30/0641

(57) ABSTRACT

In some implementations, a system may monitor online activity of a user on a user device and determine that the user is about to perform an imminent interaction associated with a domestic interaction item. The system may identify a domestic interaction amount associated with the domestic interaction item. The system may search one or more international databases for an international interaction item corresponding to the domestic interaction item and based on a prioritized order of international countries associated with the international database(s). The system may determine, based on a currency exchange rate, that an international interaction amount associated with the international interaction item is less than the domestic interaction amount. The system may transmit, to the user device, international interaction item data indicating the international interaction item, the international interaction amount, and an associated international interaction party.

### RELATED APPLICATION

This application is a continuation of U.S. patent application Ser. No. 17/821,098, filed Aug. 19, 2022, which is incorporated herein by reference in its entirety.

### BACKGROUND

Electronic commerce (e-commerce) is the activity of buying or selling goods and/or services by companies and/or individuals over the Internet. E-commerce utilizes such technologies as mobile commerce, electronic funds transfer, supply chain management, Internet marketing, online transaction processing, electronic data interchange, inventory management systems, and automated data collection systems.

### SUMMARY

Some implementations described herein relate to a system for a prioritized database search based on an imminent interaction. The system may include one or more memories and one or more processors communicatively coupled to the one or more memories. The one or more processors may be configured to monitor online activity of a user on a user device. The one or more processors may be configured to determine, based on activity data associated with the online activity, that the user is about to perform the imminent interaction associated with a domestic interaction item. The one or more processors may be configured to identify, from the activity data and based on determining that the user is about to perform the imminent interaction, a domestic interaction amount associated with the domestic interaction item. The domestic interaction amount may include a domestic interaction item amount and a domestic shipping amount. The one or more processors may be configured to search one or more international databases for item data indicating an international interaction item corresponding to the domestic interaction item. The one or more international databases may be associated with a plurality of international countries. The one or more international databases may be searched based on a prioritized order of the plurality of international countries. The prioritized order may be based on one or more factors. The one or more processors may be configured to identify, from the one or more international databases, an international interaction party that is associated with the international interaction item. The international interaction party may be based in an international country of the plurality of international countries. The one or more processors may be configured to determine a currency exchange rate from an international currency associated with the international country to a domestic currency. The one or more processors may be configured to determine, based on the currency exchange rate, that an international interaction amount associated with the international interaction item is less than the domestic interaction amount. The international interaction amount may include an international interaction item amount and an international shipping amount. The one or more processors may be configured to transmit, to the user device, international interaction item data indicating the international interaction item, the international interaction amount, and the international interaction party.

Some implementations described herein relate to a method. The method may include monitoring, by a system having one or more processors, online activity of a user. The method may include identifying, by the system and from activity data associated with the online activity, a domestic interaction item and a domestic interaction amount associated with the domestic interaction item. The method may include determining, by the system, a prioritized order of one or more international countries associated with one or more international databases, wherein the prioritized order may be based on one or more factors. The method may include searching, by the system, the one or more international databases based on the prioritized order. The method may include identifying, by the system and from the one or more international databases, an international interaction item corresponding to the domestic interaction item, and one or more international interaction parties associated with the international interaction item, wherein the one or more international interaction parties may be based in a particular international country of the one or more international countries, and wherein the one or more international interaction parties may be associated with one or more international interaction amounts of the international interaction item. The method may include comparing, by the system, the one or more international interaction amounts with the domestic interaction amount. The method may include transmitting, by the system and to a user device of the user, a notification indicating the international interaction item, one or more of the one or more international interaction amounts, and corresponding one or more of the one or more international interaction parties, if the one or more of the one or more international interaction amounts are less than the domestic interaction amount.

Some implementations described herein relate to a non-transitory computer-readable medium that stores a set of instructions for a device. The set of instructions, when executed by one or more processors of the device, may cause the device to monitor online activity of a user. The set of instructions, when executed by one or more processors of the device, may cause the device to determine, based on activity data associated with the online activity, that the user is about to perform an imminent interaction associated with a domestic interaction item. The set of instructions, when executed by one or more processors of the device, may cause the device to identify, based on determining that the user is about to perform the imminent interaction, the domestic interaction item from the activity data. The set of instructions, when executed by one or more processors of the device, may cause the device to identify, from one or more international databases associated with one or more international countries, an international interaction item corresponding to the domestic interaction item, and one or more international interaction parties associated with the international interaction item. The one or more international interaction parties may be based in a particular international country of the one or more international countries. The one or more international interaction parties may be associated with one or more international interaction amounts of the international interaction item. The set of instructions, when executed by one or more processors of the device, may cause the device to transmit, to a user device of the user, a notification indicating the international interaction item, a lowest international interaction amount, of the one or more international interaction amounts, and a corresponding international interaction party, of the one or more international interaction parties.

### BRIEF DESCRIPTION OF THE DRAWINGS

FIGS. 1A-1D are diagrams of an example associated with a prioritized database search based on an imminent interaction, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with a prioritized database search based on an imminent interaction, in accordance with some embodiments of the present disclosure.

FIG. 4 is a flowchart of an example process associated with a prioritized database search based on an imminent interaction, in accordance with some embodiments of the present disclosure.

### DETAILED DESCRIPTION

The following detailed description of example implementations refers to the accompanying drawings. The same reference numbers in different drawings may identify the same or similar elements.

Electronic commerce (e-commerce) has become a primary form of commerce for users across the world. Users are able to perform interactions for a wide variety of interaction items (e.g., goods and/or services) and with a wide variety of interaction parties (e.g., other individuals, merchants, and/or service providers) regardless of a location of the user with respect to the particular interaction party. Accordingly, a user may be able to perform an interaction with an interaction party that is located at such a distance from the user that the user could not feasibly travel to a location (e.g., a store) associated with the interaction party. As a result, users have access to a greater amount of interaction items. However, e-commerce is often limited to the particular domestic country associated with the user. Additionally, within a particular domestic country, different regions (e.g., states or provinces) may have differences in supply and/or demand of various interaction items, and as a result, the available e-commerce associated with one region may be different than another region within the same domestic country. Thus, while e-commerce has broadened the access to a greater amount of interaction items, such access is still limited. Furthermore, in some instances, a website associated with a particular interaction party may incorrectly assume a geographic region associated with the user, and therefore may provide limited access to interaction items based on the incorrect assumption. Accordingly, it is desirable for a system to maximize a user's access on a wider (e.g., global) scale to provide the user with the greatest access to interaction items.

In some implementations described herein, a system may monitor online activity of a user on a user device and determine that the user is about to perform an imminent interaction associated with a domestic interaction item. The system may identify a domestic interaction amount associated with the domestic interaction item. The system may search one or more international databases for an international interaction item corresponding to the domestic interaction item based on a prioritized order of international countries associated with the international database(s). From the search results, the system may identify one or more potential international interactions with corresponding international interaction parties for the international interaction item. If an international interaction amount associated with the potential international interaction is less than the domestic interaction amount, then the system may transmit international interaction data (e.g., the international interaction amount and the international interaction party) to the user device.

By waiting until an interaction is imminent (e.g., the interaction item was added to an online shopping cart, the user device has been on a website associated with the interaction item for longer than a duration threshold, or the user has device has accessed the website associated with the interaction item more than a number threshold) before performing the searching, the interaction analysis system is able to conserve computing resources to be used for a specific timeframe, as opposed to constantly running even when no interaction appears to be imminent. Additionally, by searching the international database(s) based on a prioritized order, the interaction analysis system is able to further conserve computing resources by limiting the scope of the search. Accordingly, the interaction analysis system is able to provide a low resource, efficient system in providing recommendations to a user.

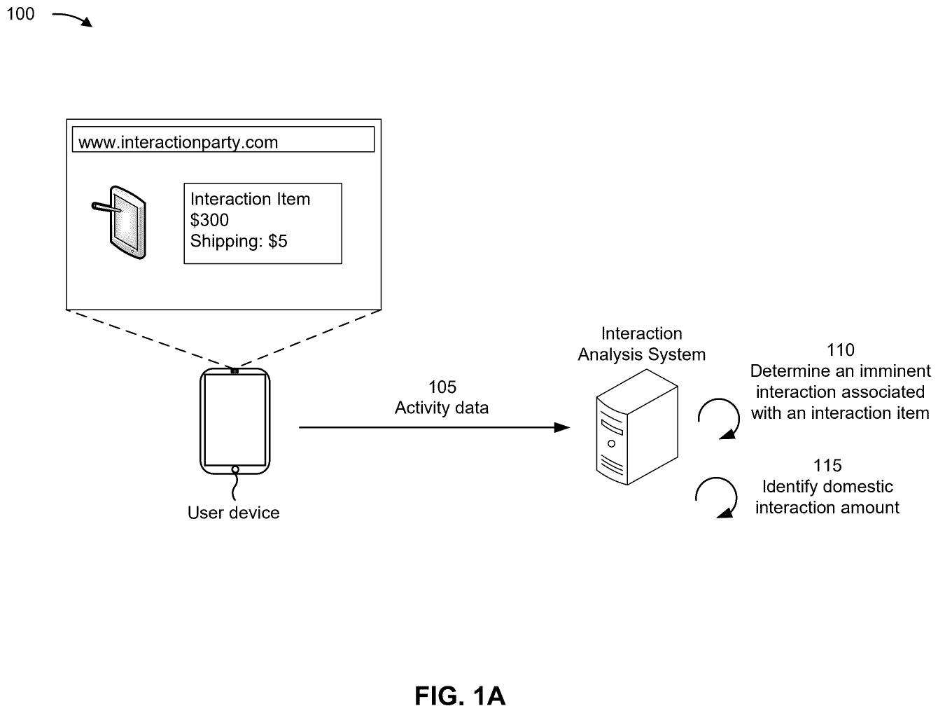

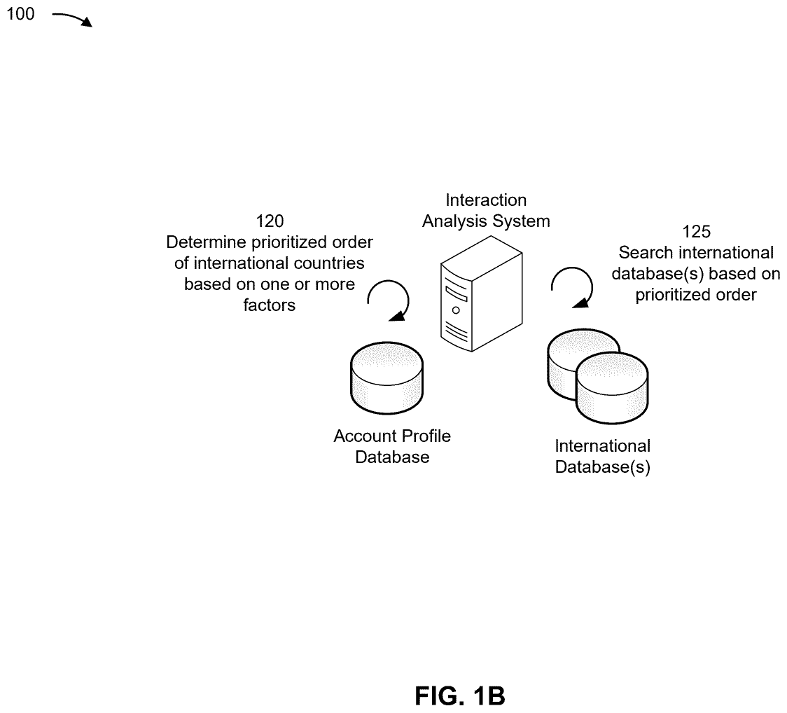

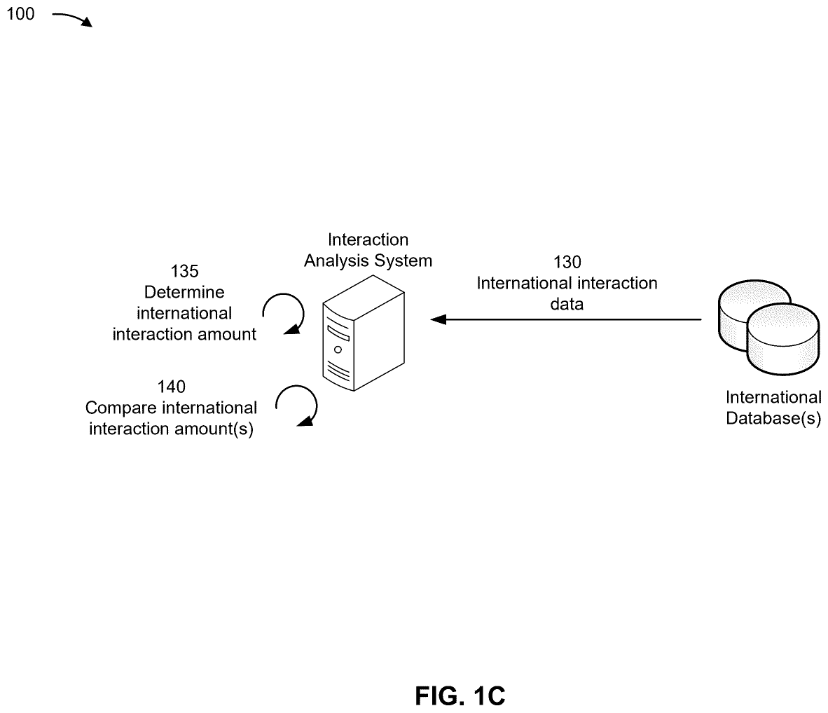

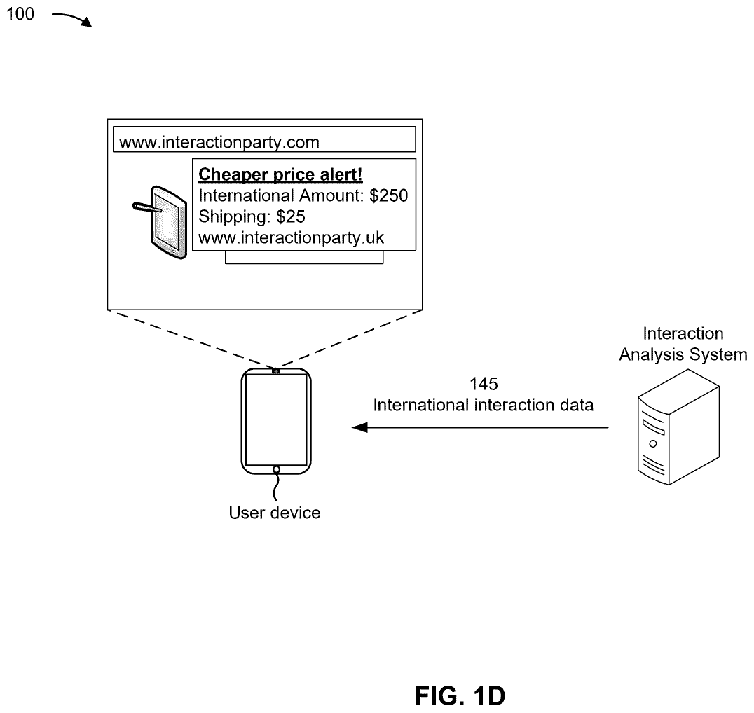

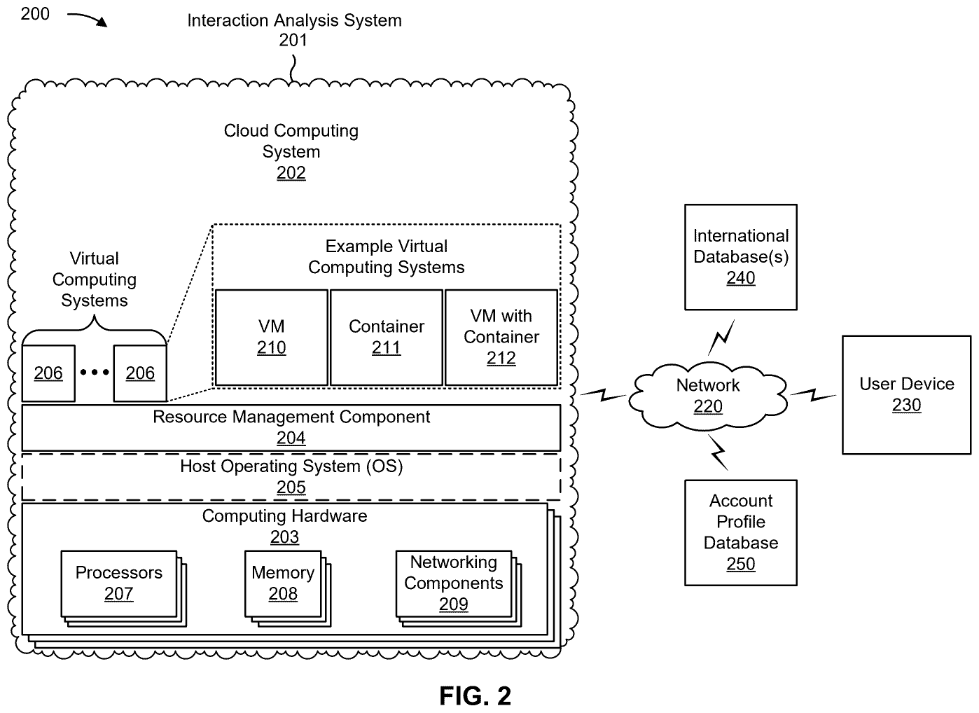

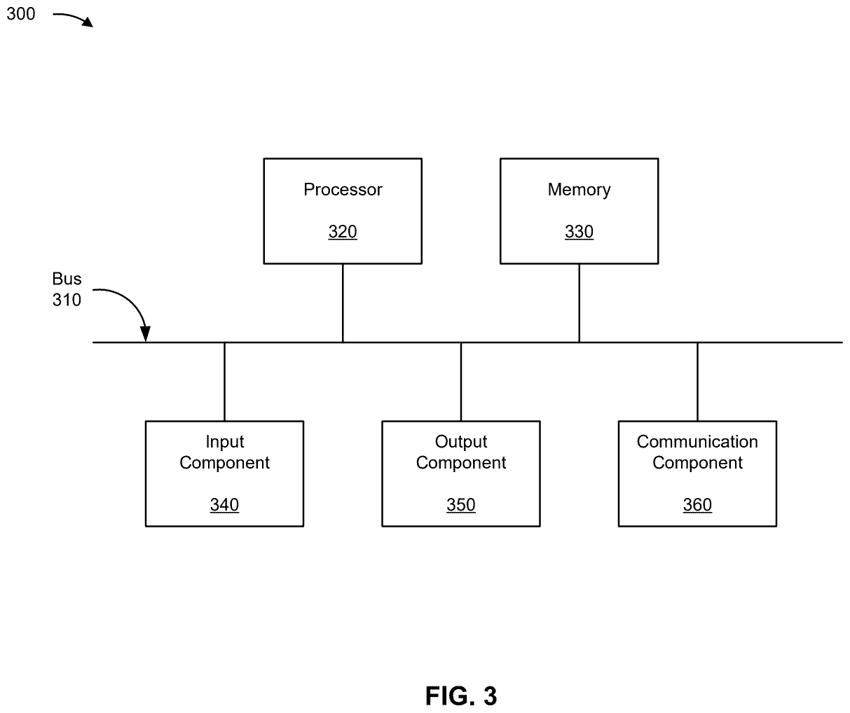

FIGS. 1A-1D are diagrams of an example 100 associated with a prioritized database search based on an imminent interaction. As shown in FIGS. 1A-1D, example 100 includes an interaction analysis system, a user device, one or more international databases, and an account profile database. These devices are described in more detail in connection with FIGS. 2 and 3.

As shown in FIG. 1A, the interaction analysis system may monitor online activity of a user (e.g., on a user device of the user). As shown by reference number 105, the interaction analysis system may receive activity data from the user device, which the interaction analysis system may monitor and analyze.

As shown by reference number 110, the interaction analysis system may determine that the user is about to perform an imminent interaction (e.g., a transaction) associated with an interaction item (e.g., a tangible product or a digital product). An interaction item is referred to as a domestic interaction item when associated with a domestic region (e.g., a domestic country) associated with the user, and as an international interaction item when associated with an international region (e.g., an international country) outside of the domestic region. While the domestic region is described as and referred to herein as a domestic country, and the international region as an international country, the domestic region may also include a region (e.g., a city, a county, a state, or a province) within a particular country, and the international region may include a region outside of that domestic region but within the same country. The imminent interaction may be a domestic interaction (e.g., performed in the domestic country) with a domestic interaction party (e.g., an individual, a merchant, or a service provider based in the domestic country).

In some implementations, the interaction analysis system may determine that the user is about to perform the imminent interaction based on the activity data associated with the user's online activity and/or historical activity data associated with historical interactions of the user and/or other users. If the activity data satisfies one or more conditions, then the interaction analysis system may determine that the user is about to perform the imminent interaction. The one or more conditions may be determined based on the historical activity data, which may be updated with each new interaction completed by one of the users.

For example, the interaction analysis system may determine, from the activity data, that the user has been on a website associated with the domestic interaction item (e.g., a product page) for a duration that exceeds a duration threshold (e.g., 5 minutes, 10 minutes, or 30 minutes). The activity data may include a timestamp of when the user device accessed the website, and the interaction analysis system may determine the duration based on the timestamp. If the duration exceeds the duration threshold, then the interaction analysis system may determine that an imminent interaction is likely to occur. Additionally, or alternatively, the interaction system may determine, from the activity data, a number of times that the user device has accessed the website associated with the domestic interaction item within a time threshold (e.g., 5 minutes, 10 minutes, or 30 minutes), which may be the same as or may be different from the duration threshold. If the number of times that the user device has accessed the website exceeds a number threshold (e.g., 3 times, 5 times, or 10 times), then the interaction analysis system may determine that the user is very interested in the domestic interaction item, and as a result, that an imminent interaction is going to occur. Additionally, or alternatively, the interaction system may determine that the user has added the domestic interaction item to an online shopping cart of the user, and therefore, that an imminent interaction is going to occur.

In some implementations, the interaction analysis system may determine the one or more conditions using a machine learning model. The machine learning model may be trained based on the historical activity data associated with the historical interactions of the user and/or other users. The machine learning model may be re-trained on current data (e.g., activity data and/or interaction data) that indicates that a user did complete an interaction. Accordingly, the conditions (e.g., the duration threshold and/or the number threshold) may be modified based on the current data.

As shown by reference number 115, the interaction analysis system may identify, from the activity and based on determining that the user is about to perform the imminent interaction, a domestic interaction amount (e.g., a cost to the user) associated with the domestic interaction item. The domestic interaction amount may include a domestic interaction item amount (e.g., a price of the domestic interaction item) and a domestic shipping amount, which may be zero (e.g., free shipping). In some scenarios, and depending on the domestic interaction item (e.g., an interaction item type associated with the domestic interaction item), the domestic interaction party, and/or a geographic location associated with the user (e.g., a state, a territory, or a province), the domestic interaction amount may include additional taxes and/or fees.

As shown in FIG. 1B, the interaction analysis system may perform an international search of one or more international databases for the interaction item to try to identify a lowest amount to the user to obtain the interaction item (e.g., an amount associated with obtaining the international interaction item that is less than the amount associated with obtaining the domestic interaction item in the imminent interaction). The international database(s) may be associated with different international countries. In some implementations, one international database may be associated with one international country (e.g., a Canadian database for Canada, a Mexican database for Mexico, and/or the like). Alternatively, one international database may be associated with multiple international countries. The international database(s) store international data (e.g., data associated with the international countries) and may be physically located at any location (e.g., domestically or internationally).

As shown by reference number 120, the interaction analysis system may determine a prioritized order of international countries based on one or more factors. In some implementations, one factor may be a proximity of the international countries to the domestic country associated with the user. For example, the prioritized order (e.g., highest priority to lowest priority) may be from the international countries having the closest proximity to the furthest proximity, where the international countries having the closest proximity may have shorter shipping times and/or shipping costs and therefore may be more desirable to search first.

Additionally, or alternatively, another factor may be based on the shipping times associated with the international countries. For example, the interaction analysis system may determine shipping times associated with the international countries from historical interaction data. The prioritized order may be in increasing order of shipping times (e.g., the international countries with the shortest shipping times may have the highest priority).

Additionally, or alternatively, another factor may be the gross domestic product (GDP) of the international countries. For example, the prioritized order may be from the international countries having the highest GDP to the smallest GDP, where the international countries having the highest GDP may have an increased likelihood of having the particular interaction item available and therefore may be more desirable and/or efficient to search first.

Additionally, or alternatively, another factor may be the size of the international countries. As an example, the prioritized order (e.g., highest priority to lowest priority) may be from the international countries having the largest size to the smallest size, where the international countries having the largest size similarly may have an increased likelihood of having the particular interaction item available and therefore may be more desirable and/or efficient to search first. Size may be defined as the population of the international countries. Alternatively, size may be defined as land area of the international countries.

Additionally, or alternatively, another factor may include an interaction item type associated with the interaction item. Examples of interaction item types may include home goods, electronics, food, furniture, and the like. Some international countries may be more associated with a particular interaction item type than other international countries. Accordingly, each interaction item type may have its own prioritized order. For example, for a first interaction item type (e.g., home goods), the prioritized order of three exemplary international countries (Country A, Country B, and Country C) may be Country A, Country B, and Country C. For a second interaction item type (e.g., electronics), the prioritized order may be Country B, Country A, and Country C.

Additionally, or alternatively, another factor may include a time of year (e.g., a particular month and/or season). During particular times of the year, different international countries may have different resources. As a result, for a particular interaction item type, one international country may be more likely to have the interaction item than another international country for a particular time of year. For example, in December (e.g., winter in the domestic country), Country A, which may be in the southern hemisphere and/or in a warmer climate during this time of year, may be more likely to have an interaction item associated with a warmer climate than Country B, which may be located in the northern hemisphere and/or in a colder climate. Accordingly, the prioritized order would be Country A, then Country B. However, in June, Country B, which may be in a warmer climate during this time of year, may be more likely to have the interaction item than Country B, which may be in a colder climate during this time of year. Accordingly, the prioritized order would be Country B, then Country A.

Additionally, or alternatively, another factor may relate to the number and/or type of requirements associated with a particular international country for shipping a particular interaction item. For example, the requirements may include customs documentation and/or customs fees (e.g., import taxes, export taxes, tariffs, or the like). Additionally, the particular requirements may vary based on the interaction item type and/or the size (e.g., volume, mass, and/or weight). For example, electronic items may have different requirements than furniture items. The requirements may be stored in the international database(s) and/or as rules in the interaction analysis system (e.g., in one or more memories of the interaction analysis system). The interaction analysis system may determine the requirements for the particular interaction item to determine the prioritized order of the international countries. In some implementations, the prioritized order may be in increasing order of the number of requirements (e.g., the international countries with the least number of requirements may have the highest priority).

Additionally, or alternatively, another factor may include one or more preferences associated with the user account of the user. For example, the user may select a particular order of international countries with which the user desires the interaction analysis system to search for the interaction item. Additionally, or alternatively, the user may include one or more international countries that the user does not want to search (e.g., because the user does not want to interact with an interaction party from that particular international country). Such user preference(s) may be stored under and accessed from the user account on the account profile database.

In some implementations, two or more of any of the exemplary factors may be combined to determine the prioritized order. For example, each factor may be weighted (e.g., based on a priority of the factors) to determine a weighted, overall prioritized order. As an example, if the prioritized order for a first factor having a highest priority is Country A, Country B, and Country C, and the prioritized order for a second factor having a lower priority is Country B, Country A, and Country C, then the weighted, overall prioritized order would be Country A, Country B, and Country C. The priority of the factors may be a set priority, as set with the interaction analysis system, or may be set by the user and stored under the user's account in the account profile database. The factors and associated prioritized orders may be stored in the international database(s), which may be accessed by the interaction analysis system, and/or may be stored in or by the interaction analysis system (e.g., as rules on one or more memories of the interaction analysis system).

In some implementations, the interaction analysis system may use a machine learning model to determine the prioritized order. The machine learning model may be trained using historical interaction data corresponding to historical interactions associated with the user and/or other users. The historical interaction data may indicate information associated with the historical interactions, such as interaction dates, interaction item types, interaction parties, and/or interaction countries. The machine learning model may be the same as or may be distinct from the machine learning model used to determine the condition(s) upon which a determination of the imminent interaction are based.

As shown by reference number 125, the interaction analysis system may search the international database(s) based on the prioritized order. For example, the interaction analysis system may search the international database(s) one international country at a time for the international version of the interaction item (e.g., the international interaction item). From the search for the international interaction item, the interaction analysis system may be able to identify one or more international interaction parties associated with the international interaction party (e.g., international interaction parties selling the international interaction item).

Additionally, or alternatively, the interaction analysis system may search the international database(s) for the one or more international interaction parties. As an example, the interaction analysis system may search for an international counterpart to the domestic interaction party. As another example, the interaction analysis system may search for one or more interaction party types (e.g., big box store or small business). The interaction party type for which the interaction analysis system searches may be based on a user preference. For example, the user account may be associated with one or more approved interaction party types. The interaction analysis system may search only for the approved interaction party types. Additionally, or alternatively, the approved interaction party types may be prioritized. For example, if the user preference is for a first interaction party type (e.g., a big box store), then the interaction analysis system may first search international interaction parties (e.g., big box stores) in the international database(s) for the interaction item.

As shown in FIG. 1C, and by reference number 130, after the interaction analysis system identifies a potential international interaction with at least one international interaction party for the international interaction item, the interaction analysis system may obtain (e.g., from the international database(s)) international interaction data associated with the potential international interaction. The international interaction data may indicate information associated with the potential international interaction, such as an international interaction item amount, the associated international interaction party, an international shipping amount, and/or an international shipping time. The international interaction party may be based in one of the international countries searched from the international database(s).

As shown by reference number 135, the interaction analysis system may determine, from the international interaction data, an international interaction amount associated with the potential international interaction. For example, the international interaction amount may include the international interaction item amount and the international shipping amount.

In some implementations, the international interaction amount may be based on a currency exchange rate from an international currency to a domestic currency (e.g., the currency associated with the domestic country of the user and the imminent interaction). For example, the interaction analysis system may identify the international country, and then may determine the currency exchange rate associated with the international country, of the international interaction party of the potential international interaction, to the domestic currency. Based on the currency exchange rate, the interaction analysis system may convert the international interaction amount from the international currency to the domestic currency. In some implementations, the user account of the user may be associated with a currency conversion fee. The international interaction amount may include the currency conversion fee.

As shown by reference number 140, the interaction analysis system may compare international interaction amount(s) corresponding to one or more potential international interactions. In some implementations, the interaction analysis system may compare the international interaction amount(s) to the domestic interaction amount. If the international interaction amount(s) are less than the domestic interaction amount, then the interaction analysis system may identify the corresponding potential international interactions to suggest to the user. Additionally, or alternatively, the interaction analysis system may compare multiple international interaction amounts with each other to determine the lowest international interaction amount or amounts. The interaction analysis system may identify the potential international interactions having the lowest international interaction amounts (e.g., the lowest, the 3 lowest, or the 5 lowest).

In some implementations, the potential international interaction(s) may be associated with estimated international shipping time(s). The interaction analysis system may compare the estimated international shipping time(s) with a shipping time threshold (e.g., 5 days, 7 days, or 2 weeks). If any of the international shipping times exceed the shipping time threshold, then the interaction analysis system will not identify the corresponding potential international interaction(s) to suggest to the user. The shipping time threshold may be a default value. In some implementations, the default value may be based on the interaction item type associated with the interaction item, for example, if the interaction item type is associated with a particular life span (e.g., an expiration date and/or a sell-by date). As an example, an interaction item type of a particular food type may be associated with an expiration date, and the default value for the shipping time threshold may correspond to a timeframe in which the expiration falls (e.g., a timeframe of 1 month may have a shipping time threshold of 5 days, a timeframe of 3 months may have a shipping time threshold of 10 days, etc.). Alternatively, the shipping time threshold may be a user preference set by the user and stored under the user account in the account profile database. Additionally, the shipping time threshold may be based

As shown in FIG. 1D, and by reference number 145, the interaction analysis system may transmit, to the user device, international interaction data corresponding to the identified potential international interactions, as described above. For each identified potential international interaction, the international interaction data may indicate the international interaction item, the international interaction party, the international interaction amount (e.g., the international interaction item amount and the international shipping amount), and/or the international shipping time. In some implementations, the international item data may be transmitted in the form of a notification (e.g., a pop-up window on the display of the user device).

In some implementations, the interaction analysis system may store records of whether or not the user completed an international interaction based on the international interaction data provided by the interaction analysis system. In implementations in which a machine learning model was used (e.g., to determine the prioritized order of the international countries), the interaction analysis system may re-train the machine learning model based on the records (e.g., whether or not the international interactions are completed by the user).

As described above, the interaction analysis system may monitor online activity of a user to determine if an interaction by the user for a particular interaction item is imminent. Based on this determination, the interaction analysis system may search international database(s) based on a prioritized order of international countries associated with the international database(s). By waiting until an interaction is imminent before performing the search, the interaction analysis system is able to conserve computing resources to be used for a specific timeframe, as opposed to constantly running even when no interaction appears to be imminent. Additionally, by searching the international database(s) based on a prioritized order, the interaction analysis system is able to further conserve computing resources by limiting the scope of the search. Accordingly, the interaction analysis system is able to provide a low resource, efficient system in providing recommendations to a user.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a interaction analysis system 201, which may include one or more elements of and/or may execute within a cloud computing system 202. The cloud computing system 202 may include one or more elements 203-212, as described in more detail below. As further shown in FIG. 2, environment 200 may include a network 220, a user device 230, international database(s) 240, and/or an account profile database 250. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the interaction analysis system 201 may include one or more elements 203-212 of the cloud computing system 202, may execute within the cloud computing system 202, and/or may be hosted within the cloud computing system 202, in some implementations, the interaction analysis system 201 may not be cloud-based (e.g., may be implemented outside of a cloud computing system) or may be partially cloud-based. For example, the interaction analysis system 201 may include one or more devices that are not part of the cloud computing system 202, such as device 300 of FIG. 3, which may include a standalone server or another type of computing device. The interaction analysis system 201 may perform one or more operations and/or processes described in more detail elsewhere herein.

Network 220 may include one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

The user device 230 may include one or more devices capable of receiving, generating, storing, processing, and/or providing information associated with a prioritized database searched based on an imminent interaction, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The international database(s) 240 may include one or more devices capable of receiving, generating, storing, processing, and/or providing information associated with a prioritized database search based on an imminent interaction, as described elsewhere herein. The international database(s) 240 may include a communication device and/or a computing device. For example, the international database(s) 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the international database(s) 240 may store data associated with international interaction items (e.g., international interaction item amounts), international interaction parties, international shipping amounts and/or times, currency exchange rates, and the like, as described elsewhere herein.

The account profile database 250 may include one or more devices capable of receiving, generating, storing, processing, and/or providing information associated with a prioritized database search based on an imminent interaction, as described elsewhere herein. The account profile database 250 may include a communication device and/or a computing device. For example, the account profile database 250 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the account profile database 250 may store user preferences, such as shipping timing thresholds, international country priorities, and the like, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with a prioritized database search based on an imminent interaction. Device 300 may correspond to the interaction analysis system 201, the user device 230, the international database(s) 240, and/or the account profile database 250. In some implementations, interaction analysis system 201, the user device 230, the international database(s) 240, and/or the account profile database 250 may include one or more devices 300 and/or one or more components of device 300. As shown in FIG. 3, device 300 may include a bus 310, a processor 320, a memory 330, an input component 340, an output component 350, and a communication component 360.

Bus 310 may include one or more components that enable wired and/or wireless communication among the components of device 300. Bus 310 may couple together two or more components of FIG. 3, such as via operative coupling, communicative coupling, electronic coupling, and/or electric coupling. Processor 320 may include a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 may include one or more processors capable of being programmed to perform one or more operations or processes described elsewhere herein.

Memory 330 may include volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 may include one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

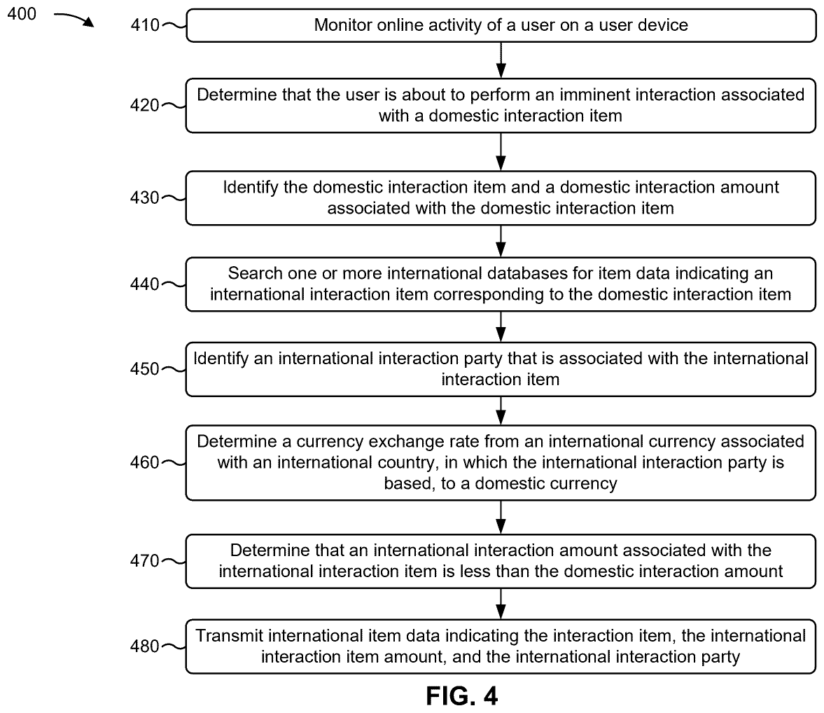

FIG. 4 is a flowchart of an example process 400 associated with a prioritized database search based on an imminent interaction. In some implementations, one or more process blocks of FIG. 4 may be performed by the interaction analysis system 201. In some implementations, one or more process blocks of FIG. 4 may be performed by one or more components of the device 300, such as processor 320, memory 330, input component 340, output component 350, and/or communication component 360.

As shown in FIG. 4, process 400 may include monitoring online activity of a user on a user device (block 410). For example, the interaction analysis system 201 (e.g., using processor 320 and/or memory 330) may monitor online activity of a user on a user device, as described above in connection with reference number 105 of FIG. 1A. As an example, the interaction analysis system may receive activity data 105 from the user device, which the interaction analysis system may monitor and analyze.

As further shown in FIG. 4, process 400 may include determining that the user is about to perform the imminent interaction associated with a domestic interaction item (block 420). For example, the interaction analysis system 201 (e.g., using processor 320 and/or memory 330) may determine, based on activity data associated with the online activity, that the user is about to perform the imminent interaction associated with a domestic interaction item, as described above in connection with reference number 110 of FIG. 1A. As an example, the interaction analysis system may determine, from the activity data, that the user is about to perform an imminent interaction (e.g., a transaction) associated with an interaction item (e.g., a tangible product or a digital product).

As further shown in FIG. 4, process 400 may include identifying the domestic interaction item and a domestic interaction amount associated with the domestic interaction item (block 430). For example, the interaction analysis system 201 (e.g., using processor 320 and/or memory 330) may identify, from the activity data and based on determining that the user is about to perform the imminent interaction, a domestic interaction amount associated with the domestic interaction item, as described above in connection with reference number 115 of FIG. 1A. As an example, the interaction analysis system may identify, from the activity and based on determining that the user is about to perform the imminent interaction, a domestic interaction amount (e.g., a cost to the user) associated with the domestic interaction item. In some implementations, the domestic interaction amount includes a domestic interaction item amount and a domestic shipping amount.

As further shown in FIG. 4, process 400 may include searching one or more international databases for item data indicating an international interaction item corresponding to the domestic interaction item (block 440). For example, the interaction analysis system 201 (e.g., using processor 320 and/or memory 330) may search one or more international databases for item data indicating an international interaction item corresponding to the domestic interaction item, as described above in connection with reference number 125 of FIG. 1B.

In some implementations, the one or more international databases may be associated with a plurality of international countries. In some implementations, the one or more international databases may be searched based on a prioritized order of the plurality of international countries. In some implementations, the prioritized order is based on one or more factors.

As further shown in FIG. 4, process 400 may include identifying an international interaction party that is associated with the international interaction item (block 450). For example, the interaction analysis system 201 (e.g., using processor 320 and/or memory 330) may identify, from the one or more international databases, an international interaction party that is associated with the international interaction item, wherein the international interaction party is based in an international country of the plurality of international countries, as described above in connection with reference number 130 of FIG. 1C. As an example, from the search for the international interaction item, the interaction analysis system may be able to identify one or more international interaction parties associated with the international interaction party (e.g., international interaction parties selling the international interaction item).

As further shown in FIG. 4, process 400 may include determining a currency exchange rate from an international currency associated with the international country to a domestic currency (block 460). For example, the interaction analysis system 201 (e.g., using processor 320 and/or memory 330) may determine a currency exchange rate from an international currency associated with the international country to a domestic currency, as described above in connection with reference number 135 of FIG. 1C. As an example, the interaction analysis system may identify the international country, and then may determine the currency exchange rate associated with the international country, of the international interaction party of the potential international interaction, to the domestic currency. Based on the currency exchange rate, the interaction analysis system may convert the international interaction amount from the international currency to the domestic currency.

As further shown in FIG. 4, process 400 may include determining, based on the currency exchange rate, that an international interaction amount associated with the international interaction item is less than the domestic interaction amount (block 470). For example, the interaction analysis system 201 (e.g., using processor 320 and/or memory 330) may determine, based on the currency exchange rate, that an international interaction amount associated with the international interaction item is less than the domestic interaction amount, as described above in connection with reference number 135 of FIG. 1C. As an example, the interaction analysis system may compare international interaction amount(s) corresponding to one or more potential international interactions. In some implementations, the interaction analysis system may compare the international interaction amount(s) to the domestic interaction amount. If the international interaction amount(s) are less than the domestic interaction amount, then the interaction analysis system may identify the corresponding potential international interactions to suggest to the user. In some implementations, the international interaction amount includes an international interaction item amount and an international shipping amount.

As further shown in FIG. 4, process 400 may include transmitting, to the user device, international interaction item data indicating the international interaction item, the international interaction amount, and the international interaction party (block 480). For example, the interaction analysis system 201 (e.g., using processor 320, memory 330, and/or communication component 360) may transmit, to the user device, international interaction item data indicating the international interaction item, the international interaction amount, and the international interaction party, as described above in connection with reference number 145 of FIG. 1D. As an example, the interaction analysis system may transmit, to the user device, international interaction data corresponding to the identified potential international interactions. For each identified potential international interaction, the international interaction data may indicate the international interaction item, the international interaction party, the international interaction amount (e.g., the international interaction item amount and the international shipping amount), and/or the international shipping time.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
one or more memories; and
one or more processors, coupled to the one or more memories, configured to:
monitor, by a device, online activity of a user accessing a website on a user device;
determine, by the device and based on monitoring the online activity and using a first machine learning model, that an interaction by the user for a particular item is imminent;
identify, from the online activity and based on determining that the interaction is imminent, a domestic interaction amount associated with the particular item;
perform, by the device and based on determining that the interaction is imminent, searching of one or more international databases for item data indicating an international item corresponding to the particular item,
wherein the one or more international databases are associated with a plurality of international countries,
wherein the one or more international databases are searched based on a prioritized order of the plurality of international countries, and
waiting to perform searching the one or more international databases until determining that the interaction is imminent;
identify, from the one or more international databases, an international interaction party that is associated with the international item,
wherein the international interaction party is based in an international country of the plurality of international countries;
determine, based on a rate, that an international interaction amount associated with the international item is less than the domestic interaction amount; and
transmit, to the user device, international item data indicating the international item, the international interaction amount, and the international interaction party.

2. The system of claim 1, wherein waiting to perform searching the one or more international databases until determining that the interaction by the user for the particular item is imminent conserves a computing resource being utilized for a specific timeframe as compared to running searches when no interaction appears to be imminent.

3. The system of claim 1, wherein determining that the interaction by the user for the particular item is imminent is based on at least one of:
a number of times the user device has accessed the website,
a duration that the user has been on the website, or
determining that the user has added the particular item to an online shopping cart based on the monitoring.

4. The system of claim 1, wherein the prioritized order is based on:
proximities of the plurality of international countries to a domestic country associated with the user,
shipping times associated with the plurality of international countries,
sizes of the plurality of international countries,
gross domestic products of the plurality of international countries, or
legal requirements associated with an international country, of the plurality of international countries, for shipping the international item.

5. The system of claim 1, wherein the prioritized order is based on whether an international country, of the plurality of international countries, is more associated with an interaction item type, associated with the particular item, than other international countries of the plurality of international countries.

6. The system of claim 1, wherein the prioritized order is based on whether an international country, of the plurality of international countries, is more likely to have the international item at a time of year than another international country of the plurality of international countries.

7. The system of claim 1, wherein the one or more processors are further configured to:
use a second machine learning model to determine the prioritized order,
wherein the second machine learning model is trained using historical interaction data corresponding to a plurality of historical interactions associated with a plurality of users, and
wherein the historical interaction data indicates interaction dates and interaction countries associated with the plurality of historical interactions; and
re-train the second machine learning model based on records of whether international interactions are completed with international interaction parties identified by the one or more processors.

8. A method, comprising:
monitoring, by a device, online activity of a user accessing a website on a user device;
determining, by the device, based on monitoring the online activity and using a first machine learning model, that an interaction by the user for a particular item is imminent;
identifying, by the device and from the online activity and based on determining that the interaction is imminent, a domestic interaction amount associated with the particular item;
performing, based on determining that the interaction is imminent, searching of one or more international databases for item data indicating an international item corresponding to the particular item,
wherein the one or more international databases are associated with a plurality of international countries,
wherein the one or more international databases are searched based on a prioritized order of the plurality of international countries, and
waiting to perform searching the one or more international databases until determining that the interaction by the user for the particular item is imminent;
identifying, by the device and from the one or more international databases, an international interaction party that is associated with the international item,
wherein the international interaction party is based in an international country of the plurality of international countries;
determining, by the device and based on a rate, that an international interaction amount associated with the international item is less than the domestic interaction amount; and
transmitting, by the device and to the user device, international item data indicating the international item, the international interaction amount, and the international interaction party.

9. The method of claim 8, wherein waiting to perform searching the one or more international databases until determining that the interaction by the user for the particular item is imminent conserves a computing resource being utilized for a specific timeframe as compared to running searches when no interaction appears to be imminent.

10. The method of claim 8, wherein determining that the interaction by the user for the particular item is imminent is based on at least one of:
a number of times the user device has accessed the website,
a duration that the user has been on the website, or
determining that the user has added the particular item to an online shopping cart based on the monitoring.

11. The method of claim 8, wherein the prioritized order is based on:
proximities of the plurality of international countries to a domestic country associated with the user,
shipping times associated with the plurality of international countries,
sizes of the plurality of international countries,
gross domestic products of the plurality of international countries, or
legal requirements associated with an international country, of the plurality of international countries, for shipping the international item.

12. The method of claim 8, wherein the prioritized order is based on whether an international country, of the plurality of international countries, is more associated with an interaction item type, associated with the particular item, than other international countries of the plurality of international countries.

13. The method of claim 8, wherein the prioritized order is based on whether an international country, of the plurality of international countries, is more likely to have the international item at a time of year than another international country of the plurality of international countries.

14. The method of claim 8, further comprising:
using a second machine learning model to determine the prioritized order,
wherein the second machine learning model is trained using historical interaction data corresponding to a plurality of historical interactions associated with a plurality of users, and
wherein the historical interaction data indicates interaction dates and interaction countries associated with the plurality of historical interactions; and
re-training the second machine learning model based on records of whether international interactions are completed with identified international interaction parties.

15. A non-transitory computer-readable medium storing a set of instructions, the set of instructions comprising:
one or more instructions that, when executed by one or more processors of a device, cause the device to:
monitor online activity of a user accessing a website on a user device;
determine, based on monitoring the online activity and using a first machine learning model, that an interaction by the user for a particular item is imminent;
identify, from the online activity and based on determining that the interaction is imminent, a domestic interaction amount associated with the particular item;
perform, based on determining that the interaction is imminent, searching of one or more international databases for item data indicating an international item corresponding to the particular item,
wherein the one or more international databases are associated with a plurality of international countries,
wherein the one or more international databases are searched based on a prioritized order of the plurality of international countries, and
waiting to perform searching the one or more international databases until determining that the interaction by the user for the particular item is imminent;
identify, from the one or more international databases, an international interaction party that is associated with the international item,
wherein the international interaction party is based in an international country of the plurality of international countries;
determine, based on a rate, that an international interaction amount associated with the international item is less than the domestic interaction amount; and
transmit, to the user device, international item data indicating the international item, the international interaction amount, and the international interaction party.

16. The non-transitory computer-readable medium of claim 15, wherein waiting to perform searching the one or more international databases until determining that the interaction by the user for the particular item is imminent conserves computing resource being utilized for a specific timeframe as compared to running searches when no interaction appears to be imminent.

17. The non-transitory computer-readable medium of claim 15, wherein determining that the interaction by the user for the particular item is imminent is based on at least one of:
a number of times the user device has accessed the website,
a duration that the user has been on the website, or
determining that the user has added the particular item to an online shopping cart based on the monitoring.

18. The non-transitory computer-readable medium of claim 15, wherein the prioritized order is based on:
proximities of the plurality of international countries to a domestic country associated with the user,
shipping times associated with the plurality of international countries,
sizes of the plurality of international countries,
gross domestic products of the plurality of international countries, or
legal requirements associated with an international country, of the plurality of international countries, for shipping the international item.

19. The non-transitory computer-readable medium of claim 15, wherein the prioritized order is based on whether an international country, of the plurality of international countries, is more associated with an interaction item type, associated with the particular item, than other international countries of the plurality of international countries.

20. The non-transitory computer-readable medium of claim 15, wherein the one or more processors are further configured to:
use a second machine learning model to determine the prioritized order,
wherein the second machine learning model is trained using historical interaction data corresponding to a plurality of historical interactions associated with a plurality of users, and
wherein the historical interaction data indicates interaction dates and interaction countries associated with the plurality of historical interactions; and
re-train the second machine learning model based on records of whether international interactions are completed with identified international interaction parties.
